(19) United States
(12) Patent Application Publication
(10) Pub. No.: US 2022/0099602 A1
(43) Pub. Date: Mar. 31, 2022

(54) In-Situ 3D printing and Non-Destructive Testing with Computer Tomography Using X-ray Flexible Detector

(71) Applicant: Jakko H Yang, Pleasanton, CA (US)

(72) Inventor: Jakko H Yang, Pleasanton, CA (US)

(21) Appl. No.: 17/033,876

(22) Filed: Sep. 27, 2020

(51) Int. Cl. G01N 23/18; G01N 23/046; G01N 23/083; B33Y 50/00; G06T 7/00; G06T 7/70; G06T 11/00

(52) U.S. Cl. CPC G01N 23/18; G01N 23/046; G01N 23/083; B33Y 50/00; G06T 7/0004; G06T 2207/10081; G06T 11/003; G01N 2223/401; G01N 2223/646; G01N 2223/645; G06T 2207/30144; G06T 7/70

(57) ABSTRACT

A method of in-situ 3D printing and Non-Destructive Testing (NDT) with Computer Tomography (CT) using X-ray flexible detector is presented. An apparatus of in-situ 3D printing and NDT using CT with X-ray flexible detector comprises a 3D printer, an X-ray source, X-ray flexible detector, data acquisition system, CT reconstruction software, CT visualization software, motion control system and a computer. Either platform of 3D build object or X-ray source, X-ray flexible detector can be on a rotation and translational stage. The apparatus with the method can automatically stop current 3D printing build, replace older part and start a new object build process based on real time CT data analysis.

### FIELD OF THE INVENTION

The present invention pertains generally to the field of system and method of 3D printing and Non-Destructive Testing (NDT) with Computer Tomography (CT).

### BACKGROUND OF THE INVENTION

There is an U.S. patent publication US20190193156A1 regarding simultaneous 3D printing and Non-Destructive Testing (NDT) with Computer Tomography (CT) using Linear Diode Array (LDA).

However, due to the fact that technology advances every day, electronics nowadays can actually be made flexible, faster, more compact and more efficient. In consumer market, a flexible solar panel charger is become popular rapidly. Now a solar panel charger can be mounted at backpack or hat etc. There are also foldable solar panels available in the market.

Just like a flexible solar panel charger, an X-ray detector can actually also be made flexible. A typical modern X-ray panel detector comprises thin-film-transistor (TFT), a layer of X-ray scintillator and read-out electronics etc. Although read-out electronics board cannot be made flexible under current technology, TFT based detector can be made flexible by using flexible substrate. Usually TFT are only sensitive to light with wavelengths at or near the visible spectrum. Therefore, the TFT requires an X-ray-to-visible-light converter in order to detect the X-rays. This converter is made of scintillating material. The layer of scintillating material, such as Gd₂O₂S:Tb (GOS or GADOX) is already made to be somewhat flexible in order to attach to flexible film for X-ray imaging purpose decades ago.

Currently, there is a problem associated with addictive manufacturing (AM) process in industry. Namely, the poor build quality is often not detected until after build completion.

If post process inspection shows that part has a quality problem, it is very likely that part will be discarded. Therefore, both precious time and material are wasted in 3D printing process.

Therefore, there is in-situ need for simultaneous 3D printing and Non-Destructive Testing (NDT). NDT is a wide group of analysis techniques used in science and industry to evaluate the properties of a material, component or system without causing damages. As one of NDT method, X-ray computed tomography (CT) is a proven effective way to precisely locate the defects inside an object. X-ray computed tomography (CT) provides a quantitative visualization of objects layer by layer as well as in 3D and this makes the CT technology particularly useful for studying the outcome of an AM process.

CT measurement can be useful not only for NDT but also for the metrological assessment of additive manufactured parts, particularly by using dimensional metrology and for material inspection of voids etc. In particular, tolerances can be contrasted between different processes with non-destructive measurement of the additive manufactured product.

A CT system includes X-ray source, X-ray detector, motion control, data acquisition and image reconstruction and visualization software etc. Due to the nature of detector 2D area, a flat panel detector using cone-beam X-ray source can cover much larger area of object at a time and therefore perform CT scan faster than that of 1D detector like LDA.

In current invention, we propose a method that is intended to save time and material at AM. During AM process, an X-ray CT system using flexible panel detector is been applied simultaneously. For this CT system, step-and-shoot working mode is sufficient in most cases.

For step-and-shoot CT, it consists of two alternative stages: data acquisition and relative positioning either from source/detector or from build platform.

During data acquisition stage, the part remains stationary at build platform and X-ray tube and detector rotates about the part to acquire a complete set of projections at a prescribed scanning location. During part relative positioning stage, no data are acquired and either part or source/detector is relatively transported to the next prescribed scanning location.

In general, electronic data acquisition is much faster than AM one layer mechanical build. Therefore, step-and-shoot CT has much more ways to improve system overall performances. As a result, even a big AM machine cost could be very high but the cost of an add-on CT system for is very low.

This CT system continuously takes NDT data and monitors the object build health status during AM process. If during AM process, computer determines that a defect is found, then depending application and defect grade, the computer has options to terminate this particular manufacturing for this object and start a new AM process. Therefore, precious resource can be saved.

Furthermore, modern CT technology makes it possible for CT NDT method to select an optimum pixel size. At flexible panel detector, changing of pixel size can be easily performed by 2D pixel binning so that CT NDT process for 3D printer can be optimized.

There are various disadvantages using LDA as X-ray detector to do NDT with CT at a 3D printing apparatus.

The first disadvantage is that LDA is difficult to bend to fit various sizes of 3D build objects and takes too much space. In this case, LDA has to be used with one-size-to-fit-all strategy. Even some long LDA can be made as pseudo curved LDA by adding small straight sections at a specific angle this arrangement can only fit to a setup with specific source to LDA distance. In reality, 3D parts can get very small and peripheral space is very tight. A 3D print machine can become desktop compact machine.

The second disadvantage is that LDA is much slower. In CT with LDA, only one slit of X-ray beam is useful for LDA, most flux of X-ray beam is wasted. When parts goes smaller, some 3D printer is quite fast. Considering space restriction, there is a possibility that data acquisition of LDA CT projection may not be able to keep up with a 3D printing speed in some cases.

The third disadvantage is that gaps between pixels are inevitable at LDA. Usually a LDA is made of many small pieces of buttable chips. When many small chip pieces are cascaded to become a long piece, there will be many gaps between each small piece. Standard space frequency of chip gaps is that there is a gap every 13 mm, 25 mm, 50 mm etc. Gaps are dead space for X-ray imaging. Due to the gaps much imaging information is lost at gaps. It is harder for software to do image reconstruction if too many pieces of information are missing.

The fourth disadvantage is that once LDA pixels are getting damaged under X-ray radiation there is no remedy due to the fact that LDA only has one line of active pixels, and in most of cases, there is no spare lines. Therefore, the only way to restore the apparatus to a normal operation condition is to buy a new LDA when the damages occur.

Compared with disadvantages in LDA, using a flexible X-ray panel detector to perform CT operations for 3D printing has following advantages.

The first advantage is that X-ray flexible detector takes less space. Usually flexible detector can be as thin as a laptop and is bendable to fit specific setup. The flexible detector can then be positioned around 3D build part closely. CT requires relative rotation between 3D build parts and detector. Because of detector curvature, the 3D printing system can save quite some space.

The second advantage is that X-ray flexible detector has better geometry for CT. Radius of X-ray flexible detector can be configured based on size of 3D built objects and X-ray source to detector distance. It is also easier for CT software to do image reconstructions.

The third advantage is that X-ray flexible detector runs much faster at CT. X-ray flexible detector covers more area and takes advantage of more X-ray flux. It collects more data at given time than that of LDA.

The fourth advantage is that electronically X-ray flexible detector is like current flat panel and there are no gaps between each pixel. In most cases, TFT is a single piece unlike multiple cascade pieces of LDA.

The fifth advantage is that X-ray flexible detector can be configured to only use one specific strip of detector region at a time. If pixels of this detector region get damaged under X-ray after long time usages, user can shift location and use other part of region without replacing whole X-ray flexible detector.

The sixth advantage is that at X-ray flexible detector, 2D binning scheme is usually available to change active pixel size in during configuration in order to optimize 3D printing with NDT. While In most cases, LDA can only do 1D binning to do scan of much lower efficiency.

### BRIEF DESCRIPTION OF THE DRAWINGS

FIG. 1 is a schematic of one embodiment of an apparatus for in-situ 3D printing and NDT with CT using X-ray flexible detector in accordance with the invention.

FIG. 2 is a schematic of an alternative embodiment of an apparatus for in-situ 3D printing and NDT with CT using X-ray flexible detector in accordance with the invention.

FIG. 3 is a schematic of an alternative embodiment of an apparatus for in-situ 3D printing and NDT with CT using X-ray flexible detector in accordance with the invention.

FIG. 4 is a schematic of an alternative embodiment of an apparatus for in-situ 3D printing and NDT with CT using X-ray flexible detector in accordance with the invention.

FIG. 5 is a schematic showing an X-ray flexible detector can be obtained by bending a straight detector into a curved geometry with specific radius.

### SUMMARY OF THE INVENTION

Generally, current invention relates to a method and a system that can provide simultaneous quality assurance of in-situ additive manufacturing during a 3D printing build process.

In particular, the quality assurance method uses X-ray Computer Tomography (CT) with X-ray flexible panel detector have non-contact, non-destructive features and can be put into automation so that large volume of high quality objects can be produced. So X-ray CT with X-ray flexible panel detector can be much easier integrated into a 3D printing system.

Either platform of 3D build or X-ray source, X-ray detector can be on a rotation and translational stage.

Using CT computer control, if defects are found in the part being built in-progress, this 3D printing process can be terminated in early stage; older part can be replaced and a new 3D printing process can be started.

### BRIEF DESCRIPTION OF THE DRAWINGS

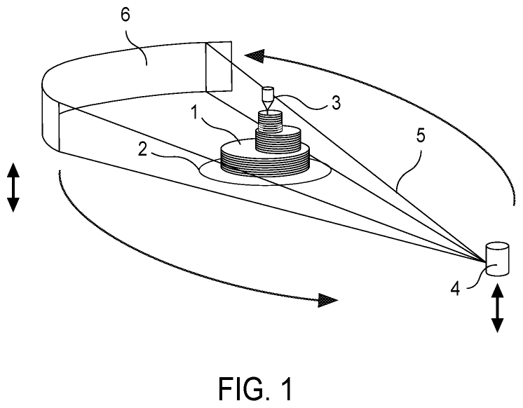

FIG. 1 is a schematic of one embodiment of an apparatus for simultaneous 3D printing and NDT with CT using X-ray flexible detector in which the 3D platform stands still while X-ray source and X-ray flexible detector rotate and move up-down together.

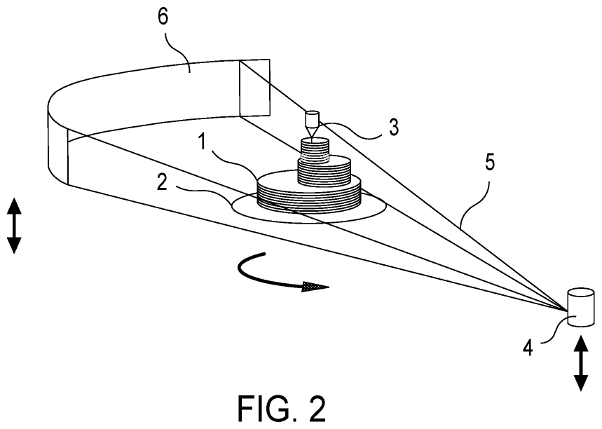

FIG. 2 is a schematic of an alternative embodiment of an apparatus for simultaneous 3D printing and NDT with CT using X-ray flexible detector in which the 3D printing platform rotates and X-ray source moves up-down along with X-ray flexible detector.

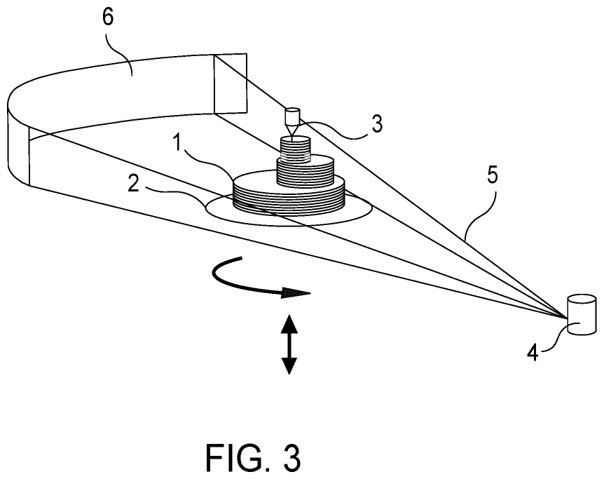

FIG. 3 is a schematic of an alternative embodiment of an apparatus for simultaneous 3D printing and NDT with CT using X-ray flexible detector in which X-ray source and X-ray detector stand still while the 3D platform rotates and moves up-down.

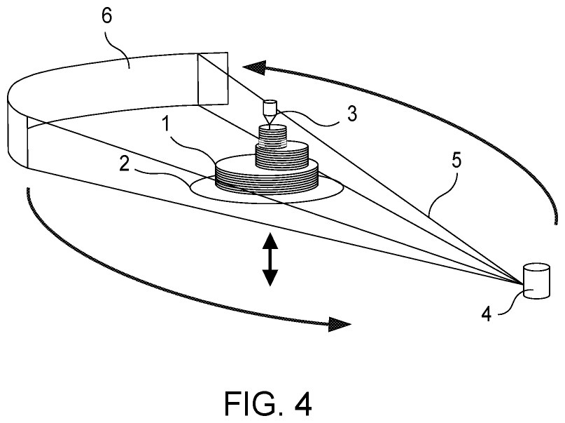

FIG. 4 is a schematic of an alternative embodiment of an apparatus for simultaneous 3D printing and NDT with CT using X-ray flexible detector in which the 3D printing platform moves up-down while X-ray source and X-ray flexible detector rotate.

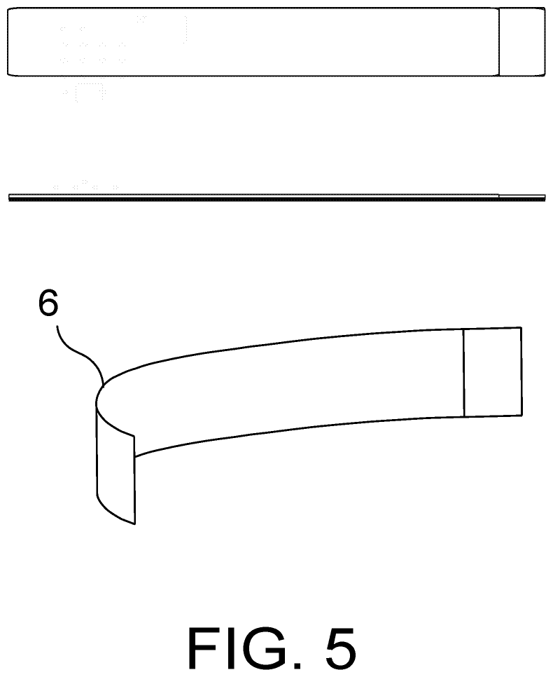

FIG. 5 shows that a straight X-ray detector is being made into an X-ray flexible detector, readout electronics PCB part is at non-flexible part while active pixel and X-ray scintillator becomes flexible part.

### DETAILED DESCRIPTION OF THE INVENTION

The present invention is a method and a system to perform in-situ 3D printing and X-ray NDT simultaneously.

The system to perform the method comprises X-ray source 4 to produce X-ray beam 5, X-ray flexible detector 6, 3D printing head 3, 3D printing object 1 and 3D printing platform 2.

Depending on different working modes, there are rotational and translational motion control mechanisms.

Referring to FIG. 1, it is one of working modes. 3D printing platform 2, 3D printing object 1 and 3D printing head 3 stand still while X-ray source 4 and X-ray flexible detector 6 can rotate and move up-down together.

FIG. 2 shows another working mode. 3D printing platform 2, 3D printing object 1 and 3D printing head 3 rotate while X-ray source 4 and X-ray flexible detector 6 move up-down.

FIG. 3 is yet another working mode. X-ray source 4 and X-ray flexible detector 6 stand still while 3D print platform 2, 3D printing object 1 and 3D printing head 3 rotates and move up-down.

FIG. 4 is still another working mode. 3D printing platform 2, 3D printing object 1 and 3D printing head 3 move up-down while X-ray source 4 and X-ray flexible detector 6 rotates.

FIG. 5 shows how to make an X-ray flexible detector 6 from a straight detector. X-ray flexible detector 6 has to use a flexible substrate. Then attachment a layer of GOS scintillator in front of TFT layer would make detector X-ray sensitive. Usually the layer of GOS scintillator is facing X-ray beam. Because both substrate layer and scintillator are flexible so the active pixel part of X-ray detector becomes flexible. Radius of X-ray flexible detector 6 can be easily adjusted based on X-ray-source-to-detector distance.

What is claimed is:

1. An method of In-Situ 3D printing and Non-Destructive Testing with Computer Tomography Using X-ray Flexible Detector, the method compromising:
a. operating an additive manufacturing system or 3D printing system to perform a build process by building a part on a build platform, the part being built by forming a series of layers of material on the build platform, the material melting and solidifying during the build process thereby creating internal defects in the part;
b. during the build process, using one or plurality of X-ray generators and one or plurality of X-ray flexible detectors to generate X-ray CT imaging data of the part;
c. storing the X-ray CT imaging data in a data logger to provide stored imaging data in the data logger; and
d. analysing the stored CT imaging data to determine whether a defect has formed during the build process, the method further comprising generating a warning if the analysis of the stored imaging data concludes that a defect has formed during the build process, wherein the warning includes an indication of a position in the part.

2. Apparatus for performing the method of claim 1, the apparatus comprising:
a. a build platform to build a part;
b. an additive manufacturing system which can be operated to perform the build process;
c. a X-ray cone beam CT system with X-ray generator, X-ray flexible detector, translational and rotational motion control system, image reconstruction and visualization software to generate CT image data of the part;
d. a data logger for storing the CT image data to provide stored CT image data in the data logger; and
e. an analysis tool configured to analyse the stored CT image data to determine whether a defect has formed during the build process, and to generate a warning if the analysis of the stored CT image data concludes that a defect has formed during the build process, wherein the warning includes an indication of a position and a size in the part.

3. The apparatus of claim 2 wherein the indication of a position in the part indicates an X, Y, Z location of the part.

4. The apparatus of claim 2 wherein either object build platform or assembly of X-ray generator and X-ray flexible detector is on a motion control.

5. The apparatus of claim 2 wherein number of X-ray generator and X-ray flexible detector is with either single piece or a plurality of pieces.

6. The apparatus of claim 2 wherein there is a sub-structure to stop build process.

7. The apparatus of claim 2 wherein there is a sub-structure to remove the old part and mount a new part.
